(19) United States
(12) Patent Application Publication
(10) Pub. No.: US 2024/0392747 A1
(43) Pub. Date: Nov. 28, 2024

(54) CONTROL METHOD, CONTROL DEVICE AND WIND FARM SYSTEM FOR WIND TURBINE FREQUENCY SUPPORT

(71) Applicant: HUAZHONG UNIVERSITY OF SCIENCE AND TECHNOLOGY, Hubei (CN)

(72) Inventors: Wei Yao, Hubei (CN); Hongyu Zhou, Hubei (CN); Yahan Yao, Hubei (CN); Xiaomeng Ai, Hubei (CN); Xia Chen, Hubei (CN); Jinyu Wen, Hubei (CN)

(73) Assignee: HUAZHONG UNIVERSITY OF SCIENCE AND TECHNOLOGY, Hubei (CN)

(21) Appl. No.: 18/396,704

(22) Filed: Dec. 27, 2023

(30) Foreign Application Priority Data
May 25, 2023 (CN) 202310600124.2

(51) Int. Cl. F03D 7/04; F03D 17/00

(52) U.S. Cl. CPC F03D 7/048; F03D 17/007; F05B 2220/30; F05B 2270/20; F05B 2270/404

(57) ABSTRACT

A control method, a control device and a wind farm system for a wind turbine frequency support are provided. The control method includes the following: calculating a comprehensive inertia power value by using a wind farm frequency modulation capability level coefficient when a frequency accident occurs in the wind farm; obtaining a real-time rotational speed of each wind turbine to calculate a state factor that changes in real time, where each wind turbine adjusts a state reference power value of its own by exchanging the state factor with a neighboring wind turbine; and determining instantaneous stator power of each wind turbine by using a MPPT part corresponding to the rotational speed, the comprehensive inertia power value, and the state reference power value, so as to control each wind turbine to perform frequency support until a predetermined frequency support time is reached.

### CROSS-REFERENCE TO RELATED APPLICATION

This application claims the priority benefit of China application serial no. 202310600124.2, filed on May 25, 2023. The entirety of the above-mentioned patent application is hereby incorporated by reference herein and made a part of this specification.

### BACKGROUND

### Technical Field

The disclosure belongs to the technical field of power system control, and in particular, relates to a control method, control device and a wind farm system for a wind turbine frequency support.

### Description of Related Art

In recent years, wind farms have become a focus for clean energy. However, wind farms cannot respond directly to system frequency deviations. As a result, as the penetration rate of wind power increases, conventional synchronous motors are replaced, the system inertia decreases, and the system frequency stability faces challenges. Therefore, in order to ensure the stable operation of the system, a wind farm is required to have the capability to actively adjust the system frequency.

In order to reduce wind curtailment, wind farms actively participate in frequency support, mainly using rotor speed control to release rotor kinetic energy, which is achieved through additional frequency support controllers. Affected by geographical distribution, wind speed, and wind direction, wind turbines at different locations in one wind farm have different wind speeds and different rotational speeds, so the frequency support capabilities of the wind turbines are different. Uniform control will prevent the frequency support capabilities of all wind turbines from being exerted and may threaten the operational stability of the wind farm. At present, the control for wind turbines frequency support is mainly divided into two types. 1. A decentralized control strategy is adopted for wind farms, and each wind turbine participates in frequency support through comprehensive inertia control. 2. A centralized control strategy is adopted for wind farms. By calculating the frequency support capability of each wind turbine, the control center issues commands to achieve the frequency support power distribution of each wind turbine. However, in the related art, wind farms are unable to strike a balance between balanced frequency support and stable operation of a power system.

### SUMMARY

In response to the above defects or the needs for improvement, the disclosure provides a control method for a wind turbine frequency support with an aim to put all wind turbines in a wind farm in the same control position through leaderless and distributed control, so each wind turbine can receive frequency deviation signals and participate in frequency modulation, so that communication failure accidents have less impact on control, leaderless control exhibits higher reliability, the state of each wind turbine in the wind farm can be followed, the power of the wind turbines in the wind farm can be distributed according to energy, and the technical problem of wind farms being unable to strike a balance between balanced frequency support and stable operation of a power system found in the related art is thereby solved.

To achieve the above, in an aspect of the disclosure, the disclosure provides a control method for a wind turbine frequency support, and the control method includes the following steps:
In S1, an initial rotational speed ω_{r,i0} and a minimum rotational speed limit ω_{r,min} of each wind turbine in a wind farm are obtained in real time to calculate a wind farm frequency modulation capability level coefficient k_{c};
In S2, when a frequency accident occurs in the wind farm, a droop coefficient k_{wdr,i} and an inertia coefficient k_{win,i} are adaptively adjusted according to the wind farm frequency modulation capability level coefficient k_{c} corresponding to a moment fb when each wind turbine fails to calculate a comprehensive inertia power value ΔP_{w,i}(t), and a real-time rotational speed ω_{r,i} of each wind turbine is obtained to calculate a state factor C; that changes in real time. Each wind turbine adjusts a state reference power value ΔP_{c,i}(t) of its own by exchanging the state factor with a neighboring wind turbine;
In S3, instantaneous stator power Pₛᵢ of each wind turbine is determined by using a MPPT part corresponding to the rotational speed, the comprehensive inertia power value ΔP_{w,i}(t), and the state reference power value ΔP_{c,i}(t), so as to control each wind turbine to perform frequency support until a predetermined frequency support time Δt is reached.

In one of the embodiments, S1 includes the following. The wind farm frequency modulation capability level coefficient

$${k}_{c} = \frac{\sum {ω}_{r , i 0}^{2} - {ω}_{r , min}^{2}}{\sum {ω}_{ref , i}^{2} - {ω}_{r , min}^{2}}$$

is calculated by using the initial rotational speed ω_{r,i0} and the minimum rotational speed limit ω_{r,min} of each wind turbine in the wind farm, where ω_{ref,i} is a wind turbine rotational speed under a predetermined wind farm state.

In one of the embodiments, S2 includes the following:
In S21, when a frequency accident occurs in the wind farm, the droop coefficient k_{wdr,i} and the inertia coefficient k_{win,i} are adaptively adjusted according to the wind farm frequency modulation capability level coefficient k_{c} corresponding to the moment fb when each wind turbine fails, and the comprehensive inertia power value ΔP_{w,i}(t) is calculated through the formula

$$Δ {P}_{w , i} ( t ) = {k}_{wdr , i} \times Δ f + {k}_{win , i} \times \frac{df}{dt} ,$$

where Δf and df/d represent a system frequency deviation and a frequency change rate respectively;
In S22, the real-time rotational speed ω_{r,i} of each wind turbine is obtained to calculate the state factor Cᵢ that changes in real time. Each wind turbine adjusts the state reference power value ΔP_{c,i}(t) of its own by exchanging the state factor with a neighboring wind turbine.

In one of the embodiments, S22 includes the following:
The state factor C; that changes in real time of an i^{th} wind turbine is calculated through the formula

$${C}_{i} = \frac{{ω}_{r , i 0}^{2} - {ω}_{r , i}^{2}}{{ω}_{r , i 0}^{2} - {ω}_{r , min}^{2}} ;$$

The state reference power value ΔP_{c,i}(t) of the i^{th} wind turbine is calculated through the formula

$$Δ {P}_{c , i} ( t ) = {k}_{P , i} {\sum }_{j = i - 1}^{i + 1} ( {c}_{j} - {c}_{i} ) + {k}_{I , i} \int {\sum }_{j = i - 1}^{i + 1} ( {c}_{j} - {c}_{i} ) ,$$

where k_{P,i} and k_{P,i} represents a proportion and an integral coefficient of a state difference between adjacent wind turbines, and Cⱼ is the state factor corresponding to the neighboring wind turbine of the i^{th} wind turbine.

In one of the embodiments, S3 includes the following:
The instantaneous stator power Pₛᵢ of the i^{th} wind turbine is determined by using Pₛᵢ=kₒₚₜω_{r,i}²+ΔP_{w,i}(t)+ΔP_{c,i}(t), so as to control each wind turbine to perform frequency support until the predetermined frequency support time Δt is reached,
where kₒₚₜω_{r,i}² represents the MPPT part corresponding to the rotational speed, and kₒₚₜ represents an optimal coefficient in a maximum power point tracking curve equation.

In one of the embodiments, 10s≤Δt≤20s.

According to another aspect of the disclosure, the disclosure further provides a control device for a wind turbine frequency support including:
An acquisition module is configured to obtain an initial rotational speed ω_{r,i0} and a minimum rotational speed limit ω_{r,min} of each wind turbine in a wind farm in real time to calculate a wind farm frequency modulation capability level coefficient k_{c};
A calculation module is configured to, when a frequency accident occurs in the wind farm, adaptively adjust a droop coefficient k_{wdr,i} and an inertia coefficient k_{win,i} according to the wind farm frequency modulation capability level coefficient k_{c} corresponding to a moment fb when each wind turbine fails to calculate a comprehensive inertia power value ΔP_{w,i}(t) and obtain a real-time rotational speed ω_{r,i} of each wind turbine to calculate a state factor Cᵢ that changes in real time. Each wind turbine adjusts a state reference power value ΔP_{c,i}(t) of its own by exchanging the state factor with a neighboring wind turbine;
A support module is configured to determine instantaneous stator power Pₛᵢ of each wind turbine by using a MPPT part corresponding to the rotational speed, the comprehensive inertia power value ΔP_{w,i}(t), and the state reference power value ΔP_{c,i}(t), so as to control each wind turbine to perform frequency support until a predetermined frequency support time Δt is reached.

According to another aspect of the disclosure, the disclosure further provides a wind farm system including a memory and a processor. The memory stores a computer program, and the processor implements the steps of the abovementioned method when executing the computer program.

In general, the above technical solutions provided by the disclosure have the following beneficial effects compared with the related art:
(1) In this solution, each wind turbine exchanges the state factor with a neighboring wind turbine, so that the wind turbines can continuously adjust their state reference power values. The state reference power value is combined with the MPPT part corresponding to the rotational speed and the comprehensive inertia power value ΔP_{w,i}(t) to determine the instant stator power Pₛᵢ of each wind turbine, so that the state of each wind turbine in the wind farm can be followed, and the power of the wind turbines in the wind farm can be distributed according to energy. Further, through leaderless and distributed control, all wind turbines in the wind farm are in the same control position, so each wind turbine can receive frequency deviation signals and participate in frequency modulation. Therefore, communication failure accidents have less impact on control, and control reliability can be improved.
(2) In the solution, an adaptive frequency modulation coefficient is used. The arrangement of this coefficient can make the degree of participation of wind turbines in the wind farm adaptively change with the frequency modulation capability of the wind farm. To be specific, by calculating the wind farm frequency modulation capability level coefficient, the frequency modulation coefficient can be adaptively adjusted, achieving that the frequency modulation coefficient of each wind turbine changes as the wind farm capability changes. It is then used to calculate the comprehensive inertia power value ΔP_{w,i}(t), so that the wind turbine rotational speed is prevented from lowering below the safety limit, and the safe operation of the wind turbines is further ensured.
(3) In the solution, the droop coefficient k_{wdr,i} and the inertia coefficient k_{win,i} are adaptively adjusted according to the wind farm frequency modulation capability level coefficient k_{c} corresponding to the moment fb when each wind turbine fails. The droop coefficient k_{wdr,i} and the inertia coefficient k_{win,i} are then used to calculate the comprehensive inertia power value. By adopting the comprehensive inertia control in the wind turbine frequency support stage, the wind turbine can actively provide frequency support, so the system inertia is improved, and the frequency stability problem caused by a large number of wind farms connected to the grid is solved.
(4) In the disclosure, by setting the state reference power value

$$Δ {P}_{c , i} ( t ) = {k}_{P , i} {\sum }_{j = i - 1}^{i + 1} ( {c}_{j} - {c}_{i} ) + {k}_{I , i} \int {\sum }_{j = i - 1}^{i + 1} ( {c}_{j} - {c}_{i} ) ,$$

where Cᵢ represents the state factor, in the wind turbine power reference value, the output of each wind turbine changes according to the state changes of its adjacent wind turbines. By matching the output of each wind turbine with its frequency support capability, the frequency modulation capability of the wind farm is maximized, and the frequency performance is improved.
(5) In the solution, the instantaneous stator power Pₛᵢ of each wind turbine is obtained by superimposing the MPPT part corresponding to the rotational speed, the comprehensive inertia power value ΔP_{w,i}(t), and the state reference power value ΔP_{c,i}(t). By adopting the comprehensive inertia control in the wind turbine frequency support stage, the wind turbine can actively provide frequency support, so the system inertia is improved, and the frequency stability problem caused by a large number of wind farms connected to the grid is solved.
(6) In this solution, the set frequency support time is 10s to 20s, and this numerical value is set after weighing. This arrangement avoids the possibility that the frequency support time is set excessively short and cannot effectively improve the system frequency performance, or that the frequency support time is set excessively long and the wind turbine rotational speed exceeds the safe range. By setting the frequency support duration range, the wind turbine can fully and safely release the rotor kinetic energy, so that frequency support for the system is achieved, and the problem of rotational speed instability when the frequency support time of the wind turbine is excessively long is solved.

### BRIEF DESCRIPTION OF THE DRAWINGS

FIG. 1 is a schematic diagram of a control method for a wind turbine frequency support according to an embodiment of the disclosure.

FIG. 2 is a diagram of control state switching of the wind turbine frequency support according to an embodiment of the disclosure.

FIG. 3 is a schematic diagram of a wind farm grid-connected four-generator and two-zone system according to an embodiment of the disclosure.

FIG. 4 is a schematic diagram of a communication link of the wind farm according to an embodiment of the disclosure.

FIG. 5 is a line chart illustrating system frequency changes with time when using different control strategies of wind turbine frequency support under the condition of disturbance of a sudden load increase of 900 MW according to an embodiment of the disclosure.

### DESCRIPTION OF THE EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the invention merely and are not used to limit the invention. In addition, the technical features involved in the various embodiments of the invention described below can be combined with each other as long as the technical features do not conflict with each other.

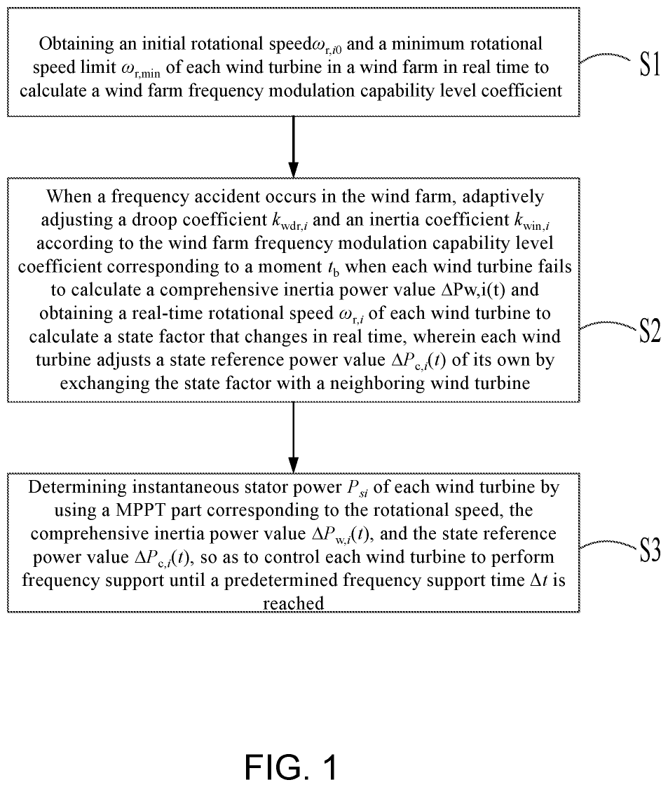

As shown in FIG. 1, the disclosure provides a control method for a wind turbine frequency support, and the control method includes the following:
In S1, an initial rotational speed ω_{r,i0} and a minimum rotational speed limit ω_{r,min} of each wind turbine in a wind farm are obtained in real time to calculate a wind farm frequency modulation capability level coefficient k_{c};
In S2, when a frequency accident occurs in the wind farm, a droop coefficient k_{wdr,i} and an inertia coefficient k_{win,i} are adaptively adjusted according to the wind farm frequency modulation capability level coefficient k_{c} corresponding to a moment fb when each wind turbine fails to calculate a comprehensive inertia power value ΔP_{w,i}(t), and a real-time rotational speed ω_{r,i} of each wind turbine is obtained to calculate a state factor C; that changes in real time. Each wind turbine adjusts a state reference power value ΔP_{c,i}(t) of its own by exchanging the state factor with a neighboring wind turbine;
In S3, instantaneous stator power Pₛᵢ of each wind turbine is determined by using a MPPT part corresponding to the rotational speed, the comprehensive inertia power value ΔP_{w,i}(t), and the state reference power value ΔP_{c,i}(t), so as to control each wind turbine to perform frequency support until a predetermined frequency support time Δt is reached.

To be specific, the main idea of the disclosure is to add the state reference power value carrying the state factor to a power reference value of each wind turbine in the wind farm. The state factors Cᵢ are exchanged between adjacent wind turbines, and further, the wind turbines all adopt adaptive frequency modulation coefficients, so that the output of the wind turbines is adjusted according to their states and the frequency modulation capability of the wind farm. In this way, the system frequency performance is improved, and unreasonable power distribution that causes the wind turbines to operate unsafely is prevented from occurring.

In one of the embodiments, S1 includes the following. A controller obtains the minimum rotational speed limit ω_{r,min} of each wind turbine WTᵢ and the initial rotational speed ω_{r,i0} of each wind turbine in the wind farm in real time and calculates the wind farm frequency modulation capability level coefficient

$${k}_{c} = \frac{\sum {ω}_{r , i 0}^{2} - {ω}_{r , min}^{2}}{\sum {ω}_{ref , i}^{2} - {ω}_{r , min}^{2}}$$

through the rotational speed of each wind turbine in a rolling manner, where ω_{ref,i} is the rotational speed of each wind turbine under a predetermined wind farm state.

In one of the embodiments, S2 includes the following: when a frequency accident occurs in the wind farm, the wind turbine frequency modulation coefficients k_{wdr,i} and k_{win,i} are adaptively adjusted according to the wind farm frequency modulation capability level coefficient k_{c} at the moment. In a time period t_{b} to t_{b}+Δt, the comprehensive inertia power value ΔP_{w,i}(t) of the leading wind turbine satisfies

$$Δ {P}_{w , i} ( t ) = {k}_{wdr , i} \times Δ f + {k}_{win , i} \times \frac{df}{dt} .$$

The droop coefficient k_{wdr,i} and the inertia coefficient k_{win,i} change with the frequency modulation capability of the wind farm according to the formulas k_{wdr,i}=k_{wdr0,i}k_{c} and k_{wdr,i}=k_{wdr0,i}k_{c}, where k_{wdr0,i} represents the base droop coefficient, and k_{wdr0,i} represents the base inertia coefficient. By setting the relationship between the power of the leading wind turbine and the change of system frequency in this way, the adaptive frequency support of the leading wind turbine to the degree of system frequency changes can be achieved. It should be noted that these are only preferred implementation of the embodiments of the disclosure and shall not be understood as the sole limitation of the disclosure. In some other embodiments of the disclosure, the droop/inertia link of the leading wind turbine may also be eliminated.

In one of the embodiments, the state reference power value is expressed as:

$$Δ {P}_{c , i} ( t ) = {k}_{P , i} {\sum }_{j = i - 1}^{i + 1} ( {c}_{j} - {c}_{i} ) + {k}_{I , i} \int {\sum }_{j = i - 1}^{i + 1} ( {c}_{j} - {c}_{i} ) ,$$

where Cᵢ represents the state factor, and its expression is

$${C}_{i} = \frac{{ω}_{r , i 0}^{2} - {ω}_{r , i}^{2}}{{ω}_{r , i 0}^{2} - {ω}_{r , min}^{2}} ,$$

which represents the deviation of the wind turbine output from the initial state.

In one of the embodiments, the wind farm is an onshore wind farm. Taking into account the effect of increasing a lowest frequency point of an onshore alternating current system and the safety of the wind turbines, a value range of frequency support time specifically is 10s≤Δt≤20s in the disclosure, and optionally Δt=11.5s in this embodiment.

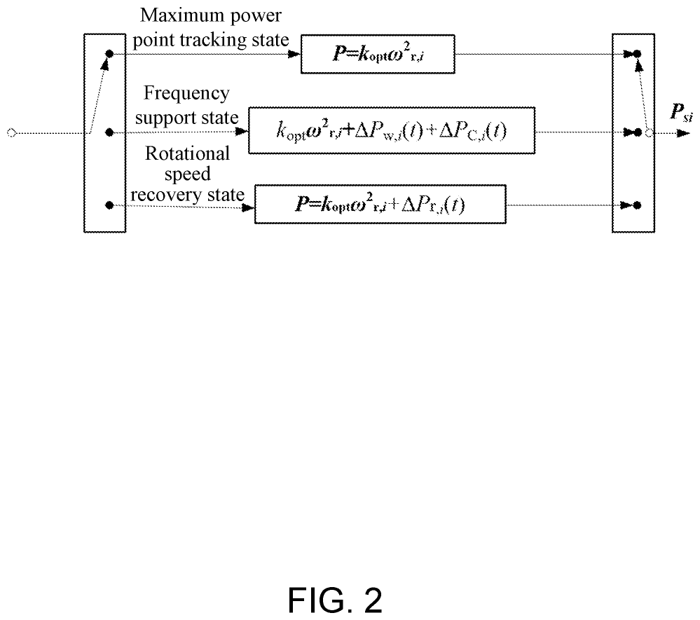

In one of the embodiments, before a wind turbine frequency is supported and after the wind turbine rotational speed is restored, a torque of each wind turbine WTᵢ is controlled, so that the instantaneous stator power Pₛᵢ and the rotational speed ω_{r,i} satisfy Pₛᵢ=kₒₚₜω_{r,i}², where kₒₚₜ represents an optimal coefficient in a maximum power point tracking curve equation. Therefore, based on the control method for the wind turbine frequency support provided by this embodiment, the state of an offshore wind farm may be divided into three states as shown in FIG. 2: a maximum power point tracking state, a frequency support state, and a rotational speed recovery state. Herein, in the maximum power point tracking state, the instantaneous stator power Pₛᵢ and rotational speed ω_{r,i} of the wind turbine satisfy Pₛᵢ=kₒₚₜω_{r,i}². In the frequency support state, an instantaneous stator power reference value Pₛᵢ of the wind turbine satisfies a constraint relationship of Pₛᵢ=kₒₚₜω_{r,i}²+ΔP_{w,i}(t)+ΔP_{c,i}(t). In the rotational speed recovery state, Pₛᵢ=kₒₚₜω_{r,i}²+ΔP_{r,i}(t), where Δ_{r,i}(t) represents additional power of a wind turbine rotational speed recovery stage.

The specific expression of the constraint relationship between the instantaneous stator power Pₛᵢ and rotational speed ω_{r,i} of the wind turbine under different states is:

$${P}_{si} = \{ \begin{matrix}{k}_{opt} {ω}_{r , i}^{2} & t < {t}_{b} \\ {k}_{opt} {ω}_{r , i}^{2} + Δ {P}_{w , i} ( t ) \times {L}_{i} + Δ {P}_{c , i} ( t ) & {t}_{b} \leq t \leq {t}_{b} + Δ t \\ {k}_{opt} {ω}_{r , i}^{2} + Δ {P}_{r , i} ( t ) & t \geq {t}_{b} + Δ t\end{matrix} ,$$

where ΔP_{r,i}(t) represents the additional power of the wind turbine rotational speed recovery stage.

In general, in this embodiment, by adding a correction term to the power reference value of each wind turbine, the state reference power value

$$Δ {P}_{c , i} ( t ) = {k}_{P , i} {\sum }_{j = i - 1}^{i + 1} ( {c}_{j} - {c}_{i} ) + {k}_{I , i} \int {\sum }_{j = i - 1}^{i + 1} ( {c}_{j} - {c}_{i} ) ,$$

where Cᵢ represents the state factor and its expression is

$${C}_{i} = \frac{{ω}_{r , i 0}^{2} - {ω}_{r , i}^{2}}{{ω}_{r , i 0}^{2} - {ω}_{r , min}^{2}} ,$$

represents the deviation of the wind turbine output relative to the initial state. The state factors Cᵢ are exchanged between adjacent wind turbines, so that the output of the wind turbines can be adjusted according to their states, the frequency modulation capability of the wind farm is fully utilized, and frequency performance is improved. In this way, unreasonable power distribution that causes the wind turbines to operate unsafely is prevented from occurring.

The beneficial effects achieved by the disclosure are further described in the following paragraphs together with a specific application scenario.

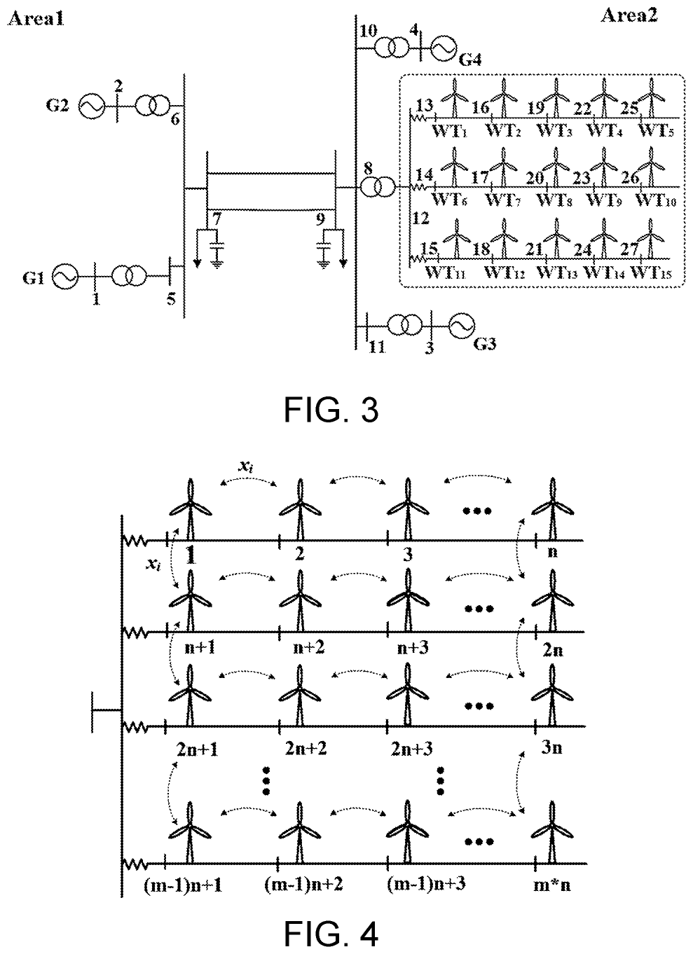

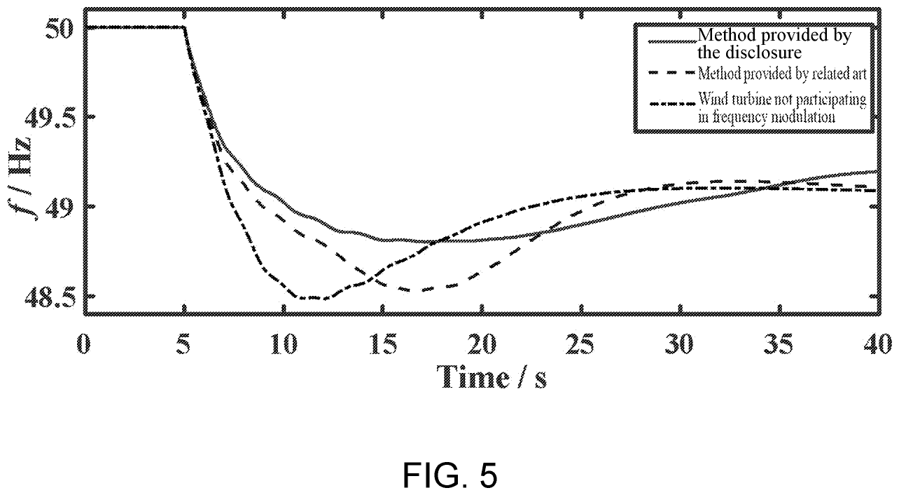

FIG. 3 shows a four-generator and two-zone power system including one wind farm, where WT₁ to WT₁₅ represent the fifteen wind turbines in the onshore wind farm, and G₁ to G₄ represent the four generators in the system. The information exchange between among the wind turbines in the wind farm is shown in FIG. 4. In the case of disturbance of a sudden load increase of 900 MW, the control provided by the disclosure, the frequency support control (centralized control) provided by the related art, and the wind turbine not participating in the frequency support control are adopted, and the system frequency changes with time is as shown in FIG. 5. Obviously, the lowest point of frequency may be increased by adopting the control provided by the disclosure.

According to another aspect of the disclosure, a control device for a wind turbine frequency support is provided, and the control device includes:
An acquisition module is configured to obtain an initial rotational speed ω_{r,i0} and a minimum rotational speed limit ω_{r,min} of each wind turbine in a wind farm in real time to calculate a wind farm frequency modulation capability level coefficient k_{c};
A calculation module is configured to, when a frequency accident occurs in the wind farm, adaptively adjust a droop coefficient k_{wdr,i} and an inertia coefficient k_{win,i} according to the wind farm frequency modulation capability level coefficient k_{c} corresponding to a moment fb when each wind turbine fails to calculate a comprehensive inertia power value ΔP_{w,i}(t) and obtain a real-time rotational speed ω_{r,i} of each wind turbine to calculate a state factor Cᵢ that changes in real time. Each wind turbine adjusts a state reference power value ΔP_{c,i}(t) of its own by exchanging the state factor with a neighboring wind turbine;
A support module is configured to determine instantaneous stator power Pₛᵢ of each wind turbine by using a MPPT part corresponding to the rotational speed, the comprehensive inertia power value ΔP_{w,i}(t), and the state reference power value ΔP_{c,i}(t), so as to control each wind turbine to perform frequency support until a predetermined frequency support time Δt is reached.

In this embodiment, specific implementation of each of the modules may be found with reference to the description of the abovementioned method, and description thereof is not repeated herein.

According to another aspect of the disclosure, a wind farm system for a wind turbine frequency support is provided, and the system includes a memory and a processor. The memory stores a computer program, and the processor implements the steps of the abovementioned method when executing the computer program.

The wind farm system in this embodiment includes a plurality of wind turbines, and the abovementioned control device for wind turbine frequency support is installed in each of the wind turbines.

A person having ordinary skill in the art shall understand that embodiments of the disclosure may be provided as methods, systems, or computer program products. Accordingly, the disclosure may take the form of an entirely hardware embodiment, an entirely software embodiment, or an embodiment that combines software and hardware aspects. Further, the disclosure may take the form of a computer program product embodied on one or more computer-usable storage media (including but not limited to a disk memory, a CD-ROM, an optical storage device, etc.) having computer-usable program code embodied therein.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. A control method for a wind turbine frequency support, comprising:
S1: obtaining an initial rotational speed ω_{r,i0} and a minimum rotational speed limit ω_{r,min} of each wind turbine in a wind farm in real time to calculate a wind farm frequency modulation capability level coefficient k_{c};
S2: when a frequency accident occurs in the wind farm, adaptively adjusting a droop coefficient k_{wdr,i} and an inertia coefficient k_{win,i} according to the wind farm frequency modulation capability level coefficient k_{c} corresponding to a moment fb when each wind turbine fails to calculate a comprehensive inertia power value ΔP_{w,i}(t) and obtaining a real-time rotational speed ω_{r,i} of each wind turbine to calculate a state factor C; that changes in real time, wherein each wind turbine adjusts a state reference power value ΔP_{c,i}(t) of its own by exchanging the state factor with a neighboring wind turbine; and
S3: determining instantaneous stator power Pₛᵢ of each wind turbine by using a MPPT part corresponding to the rotational speed, the comprehensive inertia power value ΔP_{w,i}(t), and the state reference power value ΔP_{c,i}(t), so as to control each wind turbine to perform frequency support until a predetermined frequency support time Δt is reached.

2. The control method for the wind turbine frequency support according to claim 1, wherein S1 comprises:
calculating the wind farm frequency modulation capability level coefficient
$${k}_{c} = \frac{\sum {ω}_{r , i 0}^{2} - {ω}_{r , min}^{2}}{\sum {ω}_{ref , i}^{2} - {ω}_{r , min}^{2}}$$
by using the initial rotational speed ω_{r,i0} and the minimum rotational speed limit ω_{r,min} of each wind turbine in the wind farm,
wherein ω_{ref,i} is a wind turbine rotational speed under a predetermined wind farm state.

3. The control method for the wind turbine frequency support according to claim 1, wherein S2 comprises:
S2: when a frequency accident occurs in the wind farm, adaptively adjusting the droop coefficient k_{wdr,i} and the inertia coefficient k_{win,i} according to the wind farm frequency modulation capability level coefficient k_{c} corresponding to the moment fb when each wind turbine fails and calculating the comprehensive inertia power value ΔP_{w,i}(t) through the formula
$$Δ {P}_{w , i} ( t ) = {k}_{wdr , i} \times Δ f + {k}_{win , i} \times \frac{df}{dt} ,$$
wherein Δf and df/dt represent a system frequency deviation and a frequency change rate respectively; and
S22: obtaining the real-time rotational speed @r,i of each wind turbine to calculate the state factor C; that changes in real time, wherein each wind turbine adjusts the state reference power value ΔP_{c,i}(t) of its own by exchanging the state factor with a neighboring wind turbine.

4. The control method for the wind turbine frequency support according to claim 3, wherein S22 comprises:
calculating the state factor C that changes in real time of an i^{th} wind turbine through the formula
$${C}_{i} = \frac{{ω}_{r , i 0}^{2} - {ω}_{r , i}^{2}}{{ω}_{r , i 0}^{2} - {ω}_{r , min}^{2}} ;$$
and
calculating the state reference power value ΔP_{c,i}(t) of the i^{th} wind turbine through the formula
$$Δ {P}_{c , i} ( t ) = {k}_{P , i} {\sum }_{j = i - 1}^{i + 1} ( {c}_{j} - {c}_{i} ) + {k}_{I , i} \int {\sum }_{j = i - 1}^{i + 1} ( {c}_{j} - {c}_{i} ) ,$$
wherein k_{P,i} and k_{I,i} represents a proportion and an integral coefficient of a state difference between adjacent wind turbines, and Cⱼ is the state factor corresponding to the neighboring wind turbine of the i^{th} wind turbine.

5. The control method for the wind turbine frequency support according to claim 1, wherein S3 comprises:
determining the instantaneous stator power Pₛᵢ of the i^{th} wind turbine by using Pₛᵢ=kₒₚₜω_{w,i}²+ΔP_{c,i}(t)+ΔP_{c,i}(t), so as to control each wind turbine to perform frequency support until the predetermined frequency support time Δt is reached,
wherein kₒₚₜω_{r,i}² represents the MPPT part corresponding to the rotational speed, and kₒₚₜ represents an optimal coefficient in a maximum power point tracking curve equation.

6. The control method for the wind turbine frequency support according to claim 5, wherein 10s≤Δt≤20s.

7. A control device for a wind turbine frequency support, comprising:
an acquisition module, configured to obtain an initial rotational speed ω_{r,i0} and a minimum rotational speed limit ω_{r,min} of each wind turbine in a wind farm in real time to calculate a wind farm frequency modulation capability level coefficient k_{c};
a calculation module configured to, when a frequency accident occurs in the wind farm, adaptively adjust a droop coefficient k_{wdr,i} and an inertia coefficient k_{win,i} according to the wind farm frequency modulation capability level coefficient k_{c} corresponding to a moment fb when each wind turbine fails to calculate a comprehensive inertia power value ΔP_{w,i}(t) and obtain a real-time rotational speed ω_{r,i} of each wind turbine to calculate a state factor C; that changes in real time, wherein each wind turbine adjusts a state reference power value ΔP_{c,i}(t) of its own by exchanging the state factor with a neighboring wind turbine; and
a support module, configured to determine instantaneous stator power Pₛᵢ of each wind turbine by using a MPPT part corresponding to the rotational speed, the comprehensive inertia power value ΔP_{w,i}(t), and the state reference power value ΔP_{c,i}(t), so as to control each wind turbine to perform frequency support until a predetermined frequency support time Δt is reached.

8. A wind farm system comprising a memory and a processor, wherein the memory stores a computer program, and the processor implement the steps of the control method according to claim 1 when executing the computer program.
